(19) United States
(12) Patent Application Publication
(10) Pub. No.: US 2005/0165614 A1
(43) Pub. Date: Jul. 28, 2005

(54) Method of passage and authorisation checking of objects and a device

(75) Inventor: Mikael Willgert, Spanga (SE)

Correspondence Address: ALFRED J MANGELS, 4729 CORNELL ROAD, CINCINNATI, OH, 452412433, US

(73) Assignee: Tagmaster AB, Kista (SE)

(21) Appl. No.: 10/516,193

(22) PCT Filed: May 22, 2003
(86) PCT No.: PCT/SE03/00834

(51) Int. Cl. G06F 17/60

(52) U.S. Cl. 705/1

(57) ABSTRACT

The present invention relates to a method for carrying out passage and authorisation checks of objects, such as persons or vehicles, with the aid of an identification system that uses radio frequencies, so-called RFID (Radio Frequency Identification) or corresponding radio links, said system including identification tags (ID-tags) (1) and communicators (2), wherein each ID-tag is designed to receive a signal sent by a communicator (2) and to reflect or re-send said signal in a modulated state, wherein the communicators are connected to central computer (7) and a database (8). The invention is characterised in that the memory (5) of the ID-tags includes a code which identifies the object to which the ID-tag truly belongs, said code being caused to be transferred to said computer (7) via a communicator (2); in that one or more ID-tags is/are caused to be read by a communicator (2) essentially simultaneously; in that an object-specific machine-readable parameter, such as the facial appearance of a person or the colour or shape of an object, or some other machine readable parameter, is caused to be read mechanically by a reading device (9) for one or more objects within the reading area of said device; in that the parameter read in respect of one or more objects is caused to be transferred to said computer (7); in that the computer (7) is caused to compare the read parameters with respect to the object or objects that has or have been read with corresponding stored object-specific parameters for read ID-tags; and in that in the event of a predetermined deviation between said parameters one or more ID-tags are considered not to belong to the passing objects.

(Including All Changes from the Specification in Published International Application No. PCT/SE03/00834, Publication No. WO 03/100732 A1)

### BACKGROUND OF THE INVENTION

1. Field of the Invention

The present invention relates to a method and to apparatus for checking the passage of objects, such as persons, vehicles, etc.

2. Description of the Related Art

Various automatic identification systems that utilize radio frequencies, so-called RFID (Radio Frequency Identification), and that include identification tags (ID-tags) and communicators, are known to the art. Each identification tag includes an antenna, a modulator, and a control logic circuit for controlling the modulator. One known ID-tag is designed to receive a signal sent by a communicator and to reflect this signal in a modulated state. Applicants provide such identification systems.

The use of such identification tags presents a large problem when a large number of objects pass through different passageways, such as in the case of large events, where participants or functionaries, press, etc., are issued with an ID-tag that permits passage into different areas. The problem consists in not knowing whether a person carries the tag issued to a particular person or whether the person carrying the tag has acquired the tag improperly. Known technology does not enable a reliable check to be carried out when there are no entrances through which persons pass in an orderly line one after the other, but pass through a wide entrance in a disorderly fashion.

A corresponding problem occurs when a large number of vehicles are to be checked as they pass through a given location. This problem arises in a situation where vehicles are provided with an ID-tag, which shows that a vehicle is permitted to travel into given areas of a town, for instance, and where regular vehicle toll stations for payment and/or registration are not desirable. The absence of regular vehicle passageway stations means that the vehicles are not always positioned one after the other in lines, but may be displaced relative to one another. In such cases, monitoring of passing vehicles is also desired. In this case, the problem resides in the identification and preferably marking of a vehicle that lacks an ID-tag, despite the vehicles not being in line order.

These problems are resolved by means of the present invention.

### SUMMARY OF THE INVENTION

The present invention relates to a method for carrying out passage and authorization checks of objects, such as persons or vehicles, with the aid of an identification system that uses radio frequencies, so-called RFID (Radio Frequency Identification) or corresponding radio links, the system including identification tags (ID-tags) and communicators. Each identification tag includes an antenna, a modulator, a control logic circuit for controlling the modulator, and a memory. The ID-tags are designed to receive a signal sent by a communicator and to reflect or re-send signal in a modulated state. The communicators are connected to a central computer and a database. The memory of the ID-tags includes a code which identifies the object to which the ID-tag truly belongs, the code being transferred to the computer via a communicator. One or more ID-tags are read by a communicator essentially simultaneously. An object-specific, machine-readable parameter, such as the facial appearance of a person or the color or shape of an object, or some other mechanically readable parameter, is read mechanically by a reading device for one or more objects within the reading area of the device. The parameter read in respect of one or more objects is transferred to the computer, and the computer compares the read parameters with respect to the object or objects that has or have been read with corresponding stored, object-specific parameters for read ID-tags. In the event of a predetermined deviation between the parameters, one or more ID-tags are considered not to belong to the passing objects.

The invention also relates to a control system for carrying out the method.

### BRIEF DESCRIPTION OF THE DRAWINGS

The invention will now be described in more detail, partly with reference to an exemplifying embodiment thereof illustrated in the accompanying drawings, where

FIG. 1 is a schematic block diagram illustrating a system according to the invention;

FIG. 2 illustrates schematically the monitoring of a number of persons; and

FIG. 3 illustrates schematically the monitoring of a number of cars.

### DESCRIPTION OF THE PREFERRED EMBODIMENTS

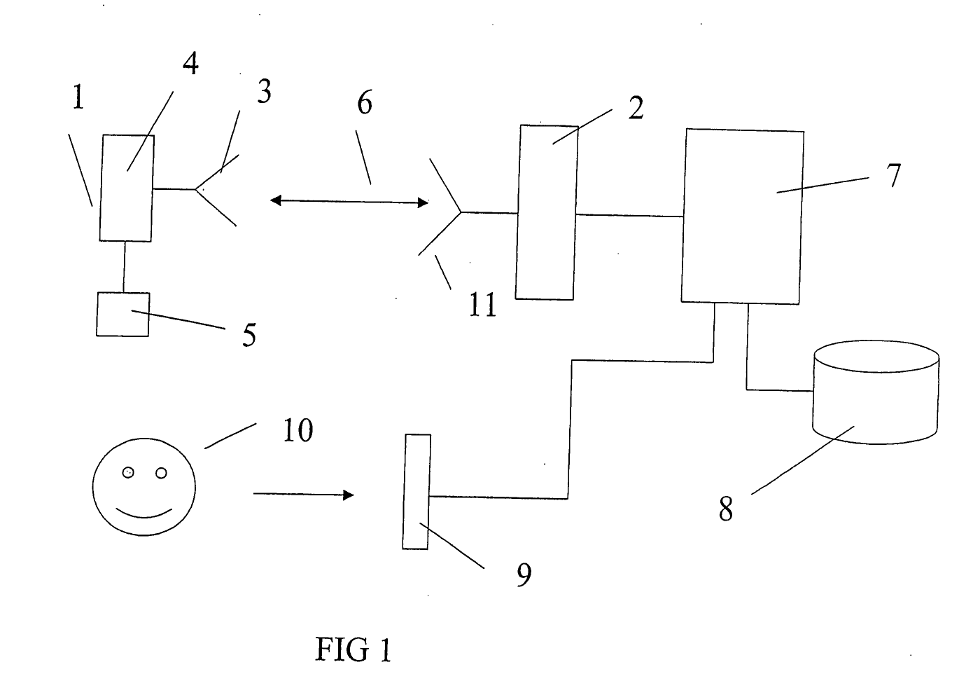

FIG. 1 illustrates an inventive system exemplified by the passage control of persons. The system includes an identification system that utilizes radio frequencies, so-called RFID (Radio Frequency Identification). The control system includes identification tags 1 (ID-tags) and communicators 2, where each identification tag 1 includes an antenna 3, a modulator, a control logic circuit 4 for controlling the modulator, and a memory 5. This ID-tag is adapted to receive a signal 6 sent by a communicator and to reflect the signal in a modulated state. The communicators also include an antenna 11.

The invention is not limited to a radio link according to RFID, and the RFID link may be replaced with a Bluetooth link between the ID-tag and the communicators.

The communicators 2 are connected to a central computer 7 and a database 8.

According to the invention, the memory 5 of respective ID-tags has stored therein a code that identifies the person to which the ID-tag 1 truly belongs. The ID-tag 1 is designed to transfer the code to a communicator 2, which is adapted to send the code to the computer 7.

The system also includes a known reader 9 for reading person-specific parameters, such as the iris of a person's eye 10, or some other machine-readable parameter.

The person-specific parameter may also consist of a picture of a person's face, or some other parameter that can be read from a distance of some meters.

According to another embodiment of the invention the person-specific parameter may be a person's height. Even a parameter as rough as this is able to ascertain whether or not the ID-tag carried by a person is the correct ID-tag issued to that person, with a relatively high degree of probability.

The reader 9 is further adapted to send the read parameter to computer 7.

According to a first embodiment, the pre-stored, person-specific parameter is stored in the ID-tag and is transferred to the computer 7 when the ID-tag is read.

According to a second embodiment, the pre-stored, person-specific parameter has been stored in the database 8 of the computer 7 and is fetched from the database to the computer with the aid of the code.

When the pre-stored, person-specific parameter has been transferred to the computer, the computer 7 functions to compare the read, person-specific parameter with the person-specific parameter fetched from the database. When the compared parameters are in predetermined agreement, the ID-tag is considered to belong to the person carrying the tag. When insufficient agreement exists, the computer 7 functions to deliver a signal that indicates that the ID-tag does not belong to the person carrying the tag.

By pre-stored, person-specific parameters is meant that reading of a parameter relating to a person may be effected, for instance, in conjunction with issuing that person with an ID-tag while, at the same time, providing the ID-tag with a person-specific code.

When using the code to fetch the person-specific parameter from the database 8, the parameter will be fetched extremely quickly. This enables a very quick comparison to be made between the stored parameter and the read parameter. Thus, it is possible to establish whether or not the ID-tag belongs to the person whose parameter was read, very quickly and with a high degree of probability.

The ID-tag may contain a large amount of information that is transferred to the computer and the database, with the exception of the previously-mentioned code. This information may contain the name, employment number, the areas in which the person is allowed to move freely, and so on.

The reader 9 that reads the parameter is preferably placed in connection with a communicator 2, so that reading of the parameter will take place essentially simultaneously with reading of the ID-tag. The previously-mentioned comparison will herewith also be made generally simultaneously.

When the person-specific parameter and ID-tag are read at some form of entrance, portal, or gate, the signal generated in the event of a predetermined deviation in the comparison may be an acoustic and/or a light signal. This will enable security guards to ensure that only authorized persons pass through the entrance.

The reader 9 may be adapted to read the parameters of two or more persons in rapid succession, in conjunction with reading respective ID-tags. In this way, it is possible to detect whether or not the number of persons agrees with the number of read ID-tags.

Many different types of readers for reading person-specific parameters are known to the art. The present invention does not rely on the use of any particular reader per se, and consequently the reader will not be described in detail in this document.

The above will be apparent from the Swedish basic priority document No. 0201578-2.

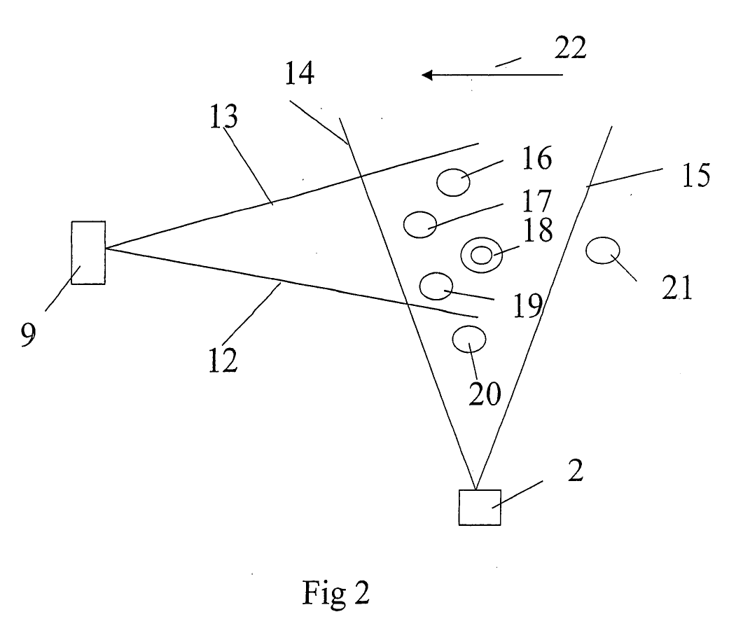

As previously mentioned, a problem arises when checking the passage of a large number of persons through a wide entrance in a disorderly fashion, such as is the case when there are no entrances through which persons pass sequentially one after the other, as illustrated in FIG. 2.

According to the present invention, one or more ID-tags are read essentially simultaneously by a communicator 2. The range of detection of the communicator 2 in FIG. 2 is delimited by the lines 14, 15. Moreover, an object-specific, machine-readable parameter, such as the facial expression of a person, or the color or shape of an object, or some other machine-readable parameter, is read mechanically by a reader 9 in respect of one or more objects, in FIG. 2 persons 16-19, within the detection range of the reader. In FIG. 2, the reading range is delimited by the lines 12, 13. The parameter read in respect of one or more persons 16-19 is sent to the computer 7, which compares the parameters read in respect of the read person or persons 16-19 with corresponding pre-stored person-specific parameters in respect of read ID-tags that have been read within the detection range of the communicator 2.

The communicator 2 and the reader 9 may be placed on a bracket structure and directed obliquely downward.

Thus, FIG. 2 shows persons 16-20 within the detection range of the communicator 2. The person 21 is situated outside the communicator detection range. Correspondingly, the persons 16-19 are situated within and the persons 20-21 are situated outside the reading range of the communicator. The person 18 is assumed not to possess an ID-tag, or to carry the ID-tag belonging to another person.

The person-specific parameters read in respect of persons 16-19 are compared in the computer 7 with the pre-stored person-specific parameters in respect of the read ID-tags belonging to persons 16-20. This means that when a comparison is made between the person-specific parameters read by the reader 9 and the detection achieved by the communicator 2, the person-specific parameters read in respect of persons 16-19 will be matched with the person-specific parameters of the persons 16-20. In the event of a predetermined deviation between those parameters, it is considered that one or more ID-tags does/do not belong to the matched object. In the case of the illustrated example, this applies only to the person 18, since the person 20 has not been detected by the reader 9.

According to one highly preferred embodiment of the reader 9, the reader 9 is a video device with which the person-specific parameter is determined by image processing. For example, as a result of image processing, the detecting device or reader 9 is able to detect one person at a time within said detection range and therewith carry out the comparison.

This means that when one or more ID-tags is/are not considered to belong to passing persons, the detector or reader may be caused to mark on an image screen those persons that are not considered to belong to any detected ID-tag. This marking on the display screen may have the form of a red ring or some other corresponding marking. Moreover, there can be taken from the detector a picture that represents the incorrect person. The embodiment in which a person is marked on the display screen is highly preferred.

According to the present invention, the reading lobes of the detector or reader 9 and the communicator 2 need not be mutually identical. FIG. 2 shows mutually intersecting lobes. However, the lobes may be directed in mutually the same direction or define angles with each other. It is important, however, that the lobes overlap.

The fact that the lobes overlap is decisive, since, in accordance with the invention, data from the ID-tags is paired together with the reading of person-specific parameters read by means of the reader 9, so as to determine whether or not a given person has the ID-tag specific to that person.

Pairing can be effected by fetching the pre-stored person-specific parameter from the computer memory 8 on the basis of the contents of the ID-tag, and thereafter comparing the fetched parameter with all parameters read by the reader 9.

Pairing can also be effected on the basis of a person-specific parameter read by the reader, by making a comparison between that parameter and all of the pre-stored parameters that are stored and connected with the ID-tags read at that moment in time, and thereafter marking read persons with which there is a predetermined deviation between the read parameter and all pre-stored parameters.

Although the invention does not guarantee absolute security against the passage of an unauthorized person or object, the probability of a person in the possession of someone else's ID-tag being able to pass because the person-specific parameter can be considered sufficiently similar to the pre-stored parameter is extremely low. In addition to application of the inventive method at entrances, gates, etc., the invention can also be applied over a wide area, for example an exhibition area or some corresponding area.

It is preferred that the computer 7 generates a signal indicating that a read ID-tag 1 is not considered to belong to the person concerned, in the absence of insufficient agreement.

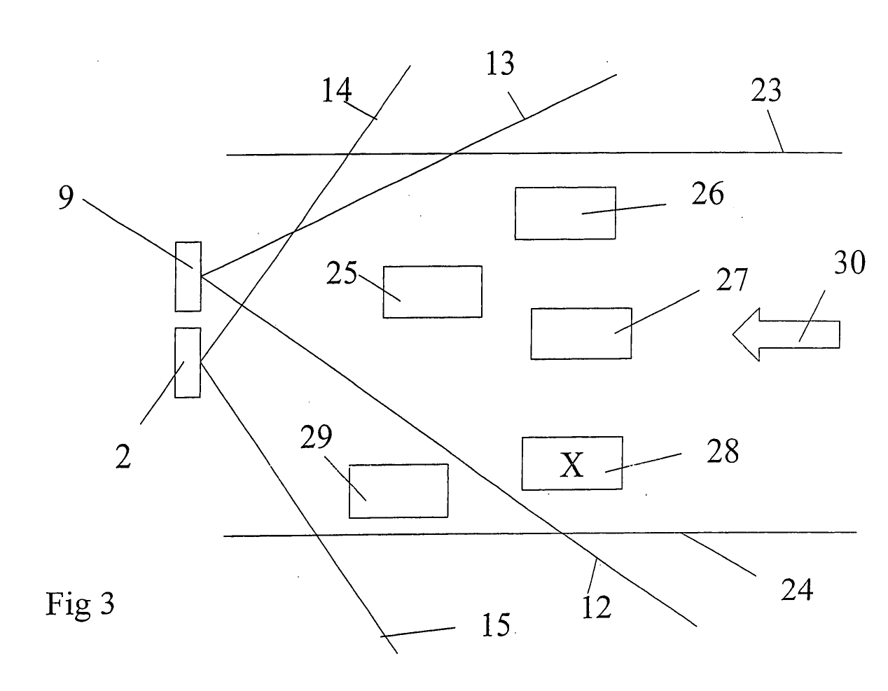

FIG. 3 illustrates a vehicle traffic monitoring system. This monitoring system may relate to permission to drive a vehicle at a specific place, vehicle toll fees, etc. Monitoring is effected with the aid of a detector or reader 9 and a communicator 2. These may be mounted on a bracket structure and directed obliquely downwards. Each vehicle 25-29 is expected to have been provided with an ID-tag 1. The vehicles move in the direction of the arrow 30.

With regard to vehicles, it is preferred that object-specific parameters include the color of the vehicle, its characteristic shape, or its registration number.

In the case of the embodiment illustrated in FIG. 3, the vehicle 28 has not been provided with an ID-tag.

Corresponding to the method illustrated in FIG. 2, the vehicles 25-28 will be matched against object-specific parameters coupled to the ID-tags that can be expected in each vehicle 25-29. The vehicles that will be matched together with pre-stored object-specific parameters are vehicles 25-27. The vehicle 29 will not be found, since the detector or reader 9 does not see that vehicle. With regard to the vehicle 28, no ID-tag is found and consequently the vehicle is considered to be false since although seeing the vehicle, the detector fails to find an ID-tag that has the correct object-specific parameter for that vehicle. As in the case of person-monitoring processes, that vehicle can be marked on an image screen and a picture of the vehicle can be produced for identification.

The present invention thus solves the earlier-mentioned problem.

It will be obvious that the invention can be modified with regard to the choice of reader, the content of the ID-tags, and the construction of the system.

The present invention is therefore not to be considered to be limited to the above-described exemplifying embodiments, since variations and modifications can be made within the scope of the accompanying claims.

1. (canceled)

2. A method according to claim 18, including the step of providing a signal indicating that a detected identification tag is not related to the accompanying object when the predetermined deviation criteria are not satisfied.

3. A method according to claim 18, wherein a device for detecting the machine-readable, object-specific parameter is placed in connection with a communicator.

4. A method according to claim 18, wherein the object is a person and the machine-readable, object-specific parameter is a readable physical parameter including at least one of a size, color, and shape characteristic of the person.

5. A method according to claim 18, wherein the object is a vehicle and the machine-readable, object-specific parameter is a readable physical parameter including at least one of a color, characteristic shape, or registration number of the vehicle.

6. A method according to claim 18, wherein the machine-readable, object-specific parameter associated with a particular object-specific code is stored in the identification tag and is transmitted to the computer when the identification tag is detected.

7. A method according to claim 18, wherein the machine-readable, object-specific parameter into associated with a particular object-specific code is stored in the database and is retrieved from the database by the computer.

8. A method according to claim 18, wherein the detection of the machine-readable, object-specific parameter is effected by a video device by image processing.

9. A method according to claim 8, wherein when at least one identification tag is determined not to belong to a passing object, the a display device identifies on a picture screen those objects that are not determined to belong to any detected identification tag.

10. (canceled)

11. A control system according to claim 21, wherein the sensing means is connected with the communicator.

12. A system according to claim 10 21, wherein the object is a person and the machine-readable, object-specific parameter is a readable physical parameter including at least one of a size, color, and shape characteristic of the person.

13. A system according to claim 21, wherein the object is a vehicle and the machine-readable, object-specific parameter is a readable physical parameter including at least one of a color, characteristic shape, or registration number of the vehicle.

14. A system according to claim 21, wherein the machine-readable, object-specific parameter associated with a particular object-specific code is stored in the identification tag and is transmitted to the computer when the identification tag is detected.

15. A system according to claim 21, wherein the machine-readable, object-specific parameter in associated with a particular object-specific code is stored in the database and is retrieved from the database by the computer.

16. A system according to claim 21, wherein the detection of the machine-readable, object-specific parameter is effected by a video device by image processing.

17. A system according to claim 16, wherein when at least one identification tag is determined not to belong to passing objects, a display device identifies on an image screen those objects that are not determined to belong to any detected identification tag.

18. A method for carrying out access passage and authorization checks of objects using a radio frequency identification link and an identification tag that includes an antenna, a modulator, a control logic circuit for controlling the modulator, and a memory, wherein when the object passes into a detection region the identification tag accompanies the object and receives a signal from a communicator and reflects the received signal to the communicator in a modulated state, and wherein the communicator is operatively connected with a computer and a database, said method comprising the steps of:
associating with the object an object-specific code;
storing the object-specific code in the identification tag memory and in the database;
associating with the object a machine-readable, object-specific parameter based upon a physical characteristic of the object;
storing the machine-readable, object-specific parameter in association with a corresponding object-specific code;
detecting the object-specific code stored in the identification tag memory as the object passes a detection region, and transmitting the detected object-specific code to the database;
as the object passes the detection region sensing the object and transmitting a sensed machine-readable, object-specific parameter to the computer;
retrieving the stored machine-readable, object-specific parameter associated with the detected object-specific code; and
comparing the retrieved machine-readable, object-specific parameter with the sensed machine-readable, object-specific parameter to determine whether they correspond within predetermined deviation criteria.

19. A method according to claim 18, wherein a plurality of objects are present simultaneously within the detection region and the object-specific codes of identification tags present within the detection region are detected, and wherein the machine-readable, object-specific parameters of the objects are each detected, and wherein the detected object-specific codes and the detected machine-readable, object-specific parameters are compared with stored codes and stored parameters to determine whether all objects within the detection region correspond with stored codes and stored parameters within predetermined deviation criteria.

20. A method according to claim 9, including the step of printing a picture of those objects that have been determined not to be validly associated with any detected identification tag.

21. A control system for carrying out access passage and authorization checks of objects using a radio frequency identification link, said system comprising:
an identification tag for accompanying an object into a detection region, wherein the identification tag includes an antenna, a modulator, a control logic circuit for controlling the modulator, and a memory;
a communicator operatively connected with a computer and a database for providing a signal to the identification tag and for receiving from the identification tag a reflected signal in a modulated state;
wherein an object-specific code is associated with the object and is stored in the identification tag memory and in the database;
a machine-readable, object-specific parameter associated with the object and based upon a physical characteristic of the object, wherein the machine-readable, object-specific parameter is stored in association with a corresponding object-specific code;
detection means for detecting the object-specific code stored in the identification tag memory as the object and identification tag pass a detection region and for transmitting a detected code to the database;
sensing means for sensing a machine-readable, object-specific parameter of the object and for transmitting the sensed parameter to the computer as the object passes the detection region;
wherein the stored machine-readable, object-specific parameter associated with the detected object-specific code is retrieved and is compared with the sensed machine-readable, object-specific parameter to determine whether they correspond within predetermined deviation criteria.

22. A system according to claim 17, including printing means for printing a picture of those objects that have been determined not to be validly associated with any detected identification tag.
